(19) United States
(12) Patent Application Publication
(10) Pub. No.: US 2026/0160782 A1
(43) Pub. Date: Jun. 11, 2026

(54) CAPACITIVE DUAL-AXIS ACCELEROMETER HAVING Z-AXIS AND MANUFACTURING METHOD THEREOF

(71) Applicant: MiraMEMS Sensing Technology Co., Ltd, SUZHOU INDUSTRIAL PARK (CN)

(72) Inventor: LI-TIEN TSENG, Taoyuan City (TW)

(21) Appl. No.: 19/298,159

(22) Filed: Aug. 12, 2025

(30) Foreign Application Priority Data
Aug. 12, 2024 (CN) 202411102769.4

(51) Int. Cl. G01P 15/125; G01P 15/08; G01P 15/18

(52) U.S. Cl. CPC G01P 15/125; G01P 15/0802; G01P 15/18; G01P 2015/0845

(57) ABSTRACT

A capacitive dual-axis accelerometer having z-axis includes a CMOS wafer, a microelectromechanical system (MEMS) wafer, and a cap wafer, all of which are disposed in parallel and bonded with each another. The MEMS wafer includes an X-axis (or Y-axis) sensing structure, a Z-axis sensing structure, four MEMS fixing anchors, and at least one stopper anchor. The X-axis (or Y-axis) sensing structure, one of which is applied depending on package orientation, shares the four MEMS fixing anchors with the Z-axis sensing structure. The at least one stopper anchor is disposed between the X-axis (or Y-axis) sensing structure and the Z-axis sensing structure, and is capable of implementing a two-stage stopper via its bump on spring and hard stopper on anchor.

### TECHNICAL FIELD

The present invention relates to a dual-axis accelerometer, and more particularly, to a capacitive dual-axis accelerometer having Z-axis and a manufacturing method thereof.

### BACKGROUNDS

A micro-electro-mechanical system (MEMS) indicates a mechanical and electromechanical system with components having mechanical functionality. The MEMS can be applied for rapid and accurate detection of minor changes in physical properties. Regarding the application of the MEMS in Z-axis accelerometers, Taiwan patent No. I762816 discloses a Z-axis seesaw accelerometer having an embedded movable structure, where the embedded movable structure can pivot or move out of a plane of the Z-axis seesaw accelerometer's beam, thereby enhancing sensitivity. Taiwan patent No. I716999 discloses a design featuring a pivot lever suspended above a wafer, with unequal spacing between the pivot lever and the wafer to improve sensitivity.

### BRIEF SUMMARY

The present invention discloses a capacitive dual-axis accelerometer having a Z-axis. A movable Z-axis seesaw structure of a MEMS wafer is disposed in a central region, surrounded by structures for inducing and sensing lateral movement (along the X-axis). A MEMS fixed anchor set grips (or holds) the movable Z-axis seesaw structure and supports the entire sensing structure at four corners.

The present invention discloses dual-axis accelerometer comprising a Z-axis. The Z-axis seesaw structure includes asymmetrical proof masses. A plurality of stopper anchor sets are arranged around the periphery of the Z-axis seesaw structure to limit excessive travel (or displacement) of the Z-axis seesaw during lateral movement along the X-axis.

The present invention discloses a capacitive dual-axis accelerometer having a Z-axis. The overall structure is symmetrical with respect to the X-axis. A stopper anchor structure is located in the hollow area between the X-axis sensing structure and the Z-axis sensing structure. The stopper anchor structure functions to absorb impact force and limit the maximum stroke of the proof mass during displacement.

The present invention discloses a capacitive dual-axis accelerometer having a Z-axis. A stopper anchor set functions as a limiting structure for both the outer X-axis proof mass and the Z-axis proof mass, providing a two-stage stopping mechanism.

In one example, the disclosed capacitive dual-axis accelerometer having a Z-axis comprises a complementary metal-oxide-semiconductor (CMOS) wafer, a micro-electro-mechanical system (MEMS) wafer, and a cap wafer. The CMOS wafer, the MEMS wafer, and the cap wafer are disposed parallel to each other and bonded together. The MEMS wafer comprises an X-axis sensing structure, a Z-axis sensing structure, four MEMS fixed anchor sets, a Z-axis pivot structure, and two stopper anchor sets. The X-axis sensing structure forming a frame that defines a hollow area. The Z-axis sensing structure is disposed within the hollow area and located at a central location within the defined frame of the X-axis sensing structure. The Z-axis sensing structure comprises a first Z-axis proof mass and a second Z-axis proof mass. The first Z-axis proof mass and second Z-axis proof mass form a seesaw proof mass. The four MEMS fixed anchor sets are respectively disposed within the hollow area at four corners of the defined frame of the X-axis sensing structure. Each the MEMS fixed anchor set comprises a connecting anchor which each the MEMS fixed anchor set uses to fix to the CMOS wafer and the cap wafer. The Z-axis pivot structure is connected to the MEMS fixed anchor sets and disposed between and connected to the first Z-axis proof mass and the second Z-axis proof mass of the Z-axis sensing structure. The two stopper anchor sets are disposed within the hollow area and located between the X-axis sensing structure and the Z-axis sensing structure, respectively. Each the stopper anchor set comprises a stopper anchor, a plurality of first connecting arms and a plurality of first stopper springs, a plurality of first spring stopper bumps, and a plurality of hard stopper bumps. The stopper anchor is respectively fixed to the CMOS wafer and the cap wafer. The plurality of first connecting arms and a plurality of first stopper springs are coupled to the stopper anchor, which is disposed between the plurality of first connecting arms and the plurality of first stopper springs. The plurality of first spring stopper bumps are located between the X-axis sensing structure or the Z-axis sensing structure and any one of the first connecting arms. A first gap is defined between each the first spring stopper bump and a first stop surface. The plurality of hard stopper bumps is located between the X-axis sensing structure or the Z-axis sensing structure and the stopper anchor. A second gap is defined between each the hard stopper bump and the first stop surface. The first gap is shorter than the second gap, and the first stop surface is from the group consisting of the X-axis sensing structure, the Z-axis sensing structure, the plurality of first connecting arms, and the stopper anchor.

In one example, each of the stopper anchor sets further comprises a plurality of second connecting arms, a plurality of second stopper springs, a plurality of second spring stopper bumps; and a plurality of second hard stopper bumps. Each the second connecting arm is orthogonally connected to each the first connecting arm. Each the second stopper spring is coupled to one of the second connecting arms and is located between the coupled second connecting arm and the Z-axis sensing structure. The plurality of second spring stopper bumps and the plurality of second hard stopper bumps are respectively disposed on the second stopper springs and are located between the plurality of second stopper springs and the Z-axis sensing structure. The height of each the second spring stopper bump is greater than the height of each the second hard stopper bump.

In one example, the capacitive dual-axis accelerometer further comprises a plurality of suspension structures; and a plurality of Z-axis suspension sets. The plurality of suspension structures are respectively connected to the Z-axis pivot structure and are located between the first Z-axis proof mass and the second Z-axis proof mass of the Z-axis sensing structure. The plurality of Z-axis suspension sets connect the suspension structures and the four MEMS fixed anchor sets.

In one example, each the MEMS fixed anchor set further comprises an electrical connection anchor, a first electrical connection spring; and a proof mass anchor. A first suspension spring connects the Z-axis suspension set and the proof mass anchor. The first electrical connection spring connects the proof mass anchor and the electrical connection anchor.

In one example, the capacitive dual-axis accelerometer further comprises a plurality of X-axis sensing comb pair structures that are disposed within the hollow area and respectively located between the X-axis sensing structure and each the Z-axis suspension set. Each the X-axis sensing comb pair structure comprises a plurality of movable electrode plates connected to the X-axis sensing structure.

In one example, the cap wafer comprises a plurality of cap pillars facing the MEMS wafer and a plurality of cap stoppers. The cap wafer and the MEMS wafer are connected via the plurality of cap pillars. The plurality of cap stoppers are positioned corresponding to the X-axis sensing structure or the Z-axis sensing structure. A height of the plurality of cap stoppers is less than a height of the plurality of cap pillars.

In one example, the capacitive dual-axis accelerometer further comprises a plurality of cap stoppers disposed on the X-axis sensing structure and/or the Z-axis sensing structure. The plurality of cap stoppers face the cap wafer and correspond to the plurality of cap pillars.

In one example, the capacitive dual-axis accelerometer further comprises a plurality of wafer stoppers disposed on the first Z-axis proof mass and/or the second Z-axis proof mass of the Z-axis sensing structure. The plurality of wafer stoppers face towards the CMOS wafer.

The present disclosure also discloses a capacitive dual-axis accelerometer that comprises a Z-axis, the accelerometer comprises a complementary metal-oxide-semiconductor (CMOS) wafer, a micro-electro-mechanical system (MEMS) wafer, and a cap wafer. The CMOS wafer, the MEMS wafer, and the cap wafer are disposed parallel to each other and bonded together. The MEMS wafer comprises an X-axis sensing structure, a Z-axis sensing structure, and a stopper anchor set. The X-axis sensing structure forms a frame defining a hollow area. The Z-axis sensing structure is disposed within the hollow area and at a central location within the frame of the X-axis sensing structure. The Z-axis sensing structure comprises a first Z-axis proof mass and a second Z-axis proof mass forming a seesaw proof mass. The stopper anchor set is disposed within the hollow area and located between the X-axis sensing structure and the Z-axis sensing structure. The stopper anchor set comprises a stopper anchor, a plurality of first connecting arms and a plurality of first stopper springs, a plurality of first spring stopper bumps, a plurality of second connecting arms, a plurality of second stopper springs, a plurality of second spring stopper bumps and a plurality of second hard stopper bumps, and a fixed anchor set. The stopper anchor is fixed to the CMOS wafer and the cap wafer. The plurality of first connecting arms and a plurality of first stopper springs are coupled to the stopper anchor. The stopper anchor is disposed between the first connecting arms and the first stopper springs. The plurality of first spring stopper bumps are located between the X-axis sensing structure or the Z-axis sensing structure and any one of the first connecting arms, A first gap is defined between each the first spring stopper bump and a first stop surface. The plurality of hard stopper bumps are located between the X-axis sensing structure or the Z-axis sensing structure and the stopper anchor. A second gap is defined between each the hard stopper bump and the first stop surface. The first gap is smaller than the second gap. The first stop surface is from the group consisting of the X-axis sensing structure, the Z-axis sensing structure, the first connecting arms, and the stopper anchor. Each of the plurality of second connecting arms is orthogonally connected to each the first connecting arm. Each of the plurality of second stopper springs is coupled to one of the second connecting arms. The plurality of second spring stopper bumps and a plurality of second hard stopper bumps are located between the plurality of second stopper springs and the Z-axis sensing structure. The fixed anchor set is disposed within the hollow area. The X-axis sensing structure and the Z-axis sensing structure are respectively fixed to the cap wafer and electrically connected to the CMOS wafer, via the fixed anchor set. The fixed anchor set comprises a Z-axis pivot structure, a plurality of suspension structures, a plurality of Z-axis suspension sets, and a plurality of MEMS fixed anchor sets. The Z-axis pivot structure is located between and connected to the first proof mass and the second proof mass of the Z-axis sensing structure. The plurality of suspension structures are respectively connected to the Z-axis pivot structure and located between the first proof mass and the second proof mass of the Z-axis sensing structure. Each the suspension structure comprises a first elastic beam and a second elastic beam orthogonal to each other. One end of the first elastic beam is connected to the Z-axis pivot structure and the other end of the first elastic beam is connected to the second elastic beam. The plurality of Z-axis suspension sets connected to the plurality of second elastic beams. The plurality of MEMS fixed anchor sets are located at four corners of the frame of the X-axis sensing structure and connected to the Z-axis suspension sets. Each the MEMS fixed anchor set comprises a proof mass anchor, a first electrical connection spring, and an electrical connection anchor. The electrical connection anchor is fixed to the CMOS wafer and the cap wafer. The first electrical connection spring connects the proof mass anchor and the electrical connection anchor. Each the MEMS fixed anchor set is connected to the cap wafer via the proof mass anchor.

The present invention also discloses a method of fabricating the capacitive dual-axis accelerometer disclosed above. The method comprises providing the cap wafer; fusion bonding an original wafer to the cap wafer; patterning the original wafer to form the MEMS wafer; providing the CMOS wafer; and eutectically bonding the MEMS wafer and the CMOS wafer.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, some preferred embodiments are shown in the drawings. It should be understood, however, that the present invention is not limited to the precise arrangements and instrumentalities shown.

In the drawings:

FIG. 1 is a top-view diagram illustrating a structural disposition of an X-axis sensing structure and a Z-axis sensing structure of a MEMS wafer according to a first embodiment of the present invention.

FIG. 2 is a top-view diagram illustrating an X-axis flexible structure and a partial structure of a common structural anchor shared by a ring-shaped proof mass and the Z-axis sensing structure according to the first embodiment of the present invention.

FIG. 3 is a top-view diagram of a pivoting structure of a MEMS wafer from the first embodiment of the present invention, which forms a second embodiment of the present invention.

FIG. 4 is a top-view diagram of a pivoting structure of a MEMS wafer from the first embodiment of the present invention, which forms a third embodiment of the present invention.

FIG. 5 is a top-view diagram of partial structures of an X-axis sensing structure (in which an X-axis ring-shaped proof mass includes a sensing structure), a Z-axis sensing structure, and a stopper anchor of the MEMS wafer according to the first embodiment of the present invention.

FIG. 6 is a partial zoom-in diagram of FIG. 5.

FIG. 7 is a top-view diagram of partial structures of an X-axis sensing structure and a stopper anchor of the MEMS according to the second embodiment of the present invention.

FIG. 8 is a top-view diagram of partial structures of an X-axis sensing structure and a Z-axis sensing structure of the MEMS according to the second embodiment of the present invention.

FIG. 9 is a structural lateral-view diagram of a X/Z-axes accelerometer according to an embodiment of the present invention.

FIG. 10 is another structural lateral-view diagram of a X/Z-axes accelerometer according to an embodiment of the present invention.

FIGS. 11-21 illustrate procedural sectional-view diagram of a X/Z-axes accelerometer according to some embodiments of the present invention.

### DETAILED DESCRIPTION

Reference will now be made in detail to the examples of the invention, which are illustrated in the accompanying drawings. Wherever possible, the same reference numbers will be used throughout the drawings to refer to the same or like parts.

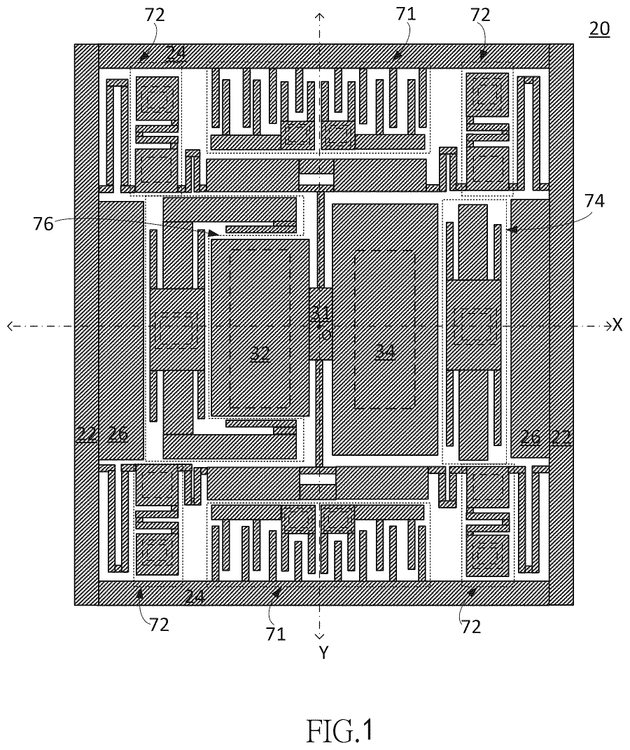

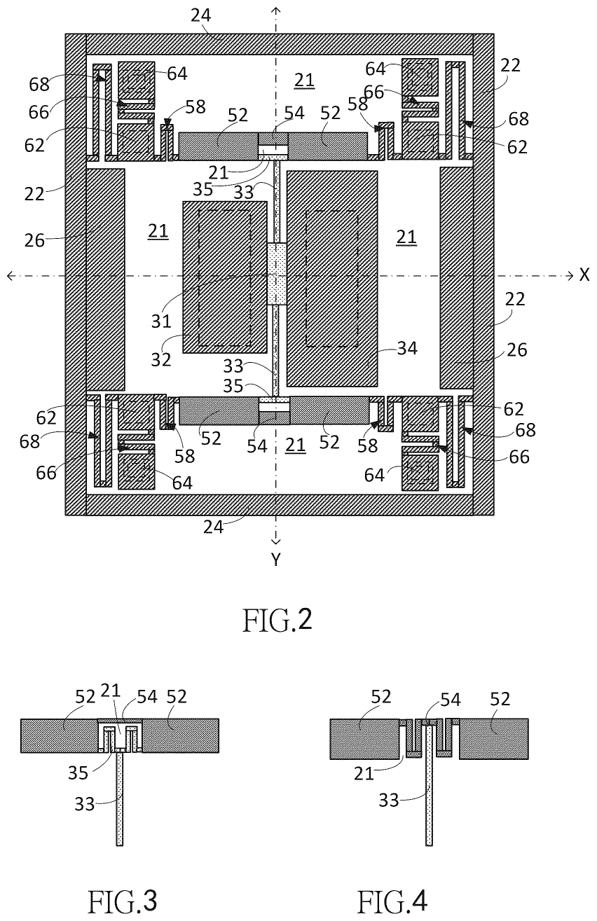

FIG. 1 is a top-view diagram illustrating a structural disposition of an X-axis sensing structure and a Z-axis sensing structure of a MEMS wafer according to a first embodiment of the present invention. FIG. 2 is a top-view schematic diagram that illustrates a portion of the MEMS wafer shown in FIG. 1 that includes an X-axis elastic structure, a ring-shaped proof mass, and a shared anchor structure for the X-axis sensing structure and the Z-axis sensing structure, according to the first embodiment of the present invention. FIG. 3 is a top-view diagram of a pivoting structure of a MEMS wafer from the first embodiment of the present invention, which forms a second embodiment of the present invention. FIG. 4 is a top-view diagram of a pivoting structure of a MEMS wafer from the first embodiment of the present invention, which forms a third embodiment of the present invention. It is noted that FIG. 1 is used for describing the disposition of structures of the MEMS wafer of the present invention, such that FIG. 1 may not show the structures in detail; however, said details can be referred to figures other than FIG. 1 in the present disclosure.

Please refer to FIG. 1 and FIG. 2. A MEMS wafer 20 includes an X-axis sensing structure, a Z-axis sensing structure, and a hollow area 21. The X-axis sensing structure includes multiple first proof masses 22, multiple proof masses 24 and multiple proof masses 26. The first proof masses 22 and the second proof masses 24 form a frame, in which the hollow area 21 is surrounded. The Z-axis sensing structure is located in the center of a surrounded region surrounded by the X-axis sensing structure. Also, the two third proof masses 26 of the X-axis sensing structure are respectively connected and fixed onto the first proof masses 22 and located inside the hollow area 21. In other words, the X-axis sensing structure of the first embodiment is an X-axis proof mass frame structure that surrounds the Z-axis sensing structure.

Please refer to FIG. 1 and FIG. 2 again. The Z-axis sensing structure includes a second Z-axis proof mass 32, a first Z-axis proof mass 34, and a Z-axis pivot structure 31, which respectively connects to a first suspension structure 52 and a second suspension structure 54 via a first elastic beam 33 and a second elastic beam 35. The Z-axis pivot structure 31 is disposed roughly in a middle section between the second Z-axis proof mass 32 and the first Z-axis proof mass 34. The center O of the frame is located at the center of the Z-axis pivot structure 31, in other words, the Z-axis pivot structure 31 passes through the center of an intersection of the X-axis and the Y-axis. Dotted regions within the illustrated Z-axis proof mass 32 and the first Z-axis proof mass 34 respectively indicate sensing electrode pads of an under CMOS wafer, which is symmetric to the Y-axis of the MEMS wafer 20 according to the first embodiment of the present invention. Second, the second Z-axis proof mass 32 and the first Z-axis proof mass 34 have a similar geometric shape but differ in mass. In the first embodiment of the present invention, the second Z-axis proof mass 32 is geometrically different with the first Z-axis proof mass 34 in size, so as to form an asymmetric sensing structure that constitutes a Z-axis sensing see-saw structure which is held by the Z-axis pivot structure 31. In addition, the Z-axis sensing see-saw structure generates an inertia moment difference to spin along with the Z-axis pivot structure 31.

Please refer to FIG. 1 and FIG. 2 again. In the first embodiment of the present invention, the Z-axis pivot structure 31 and the multiple Z-axis flexible structure set respectively extend from the Z-axis pivot structure 31 to reach within the hollow area 21, where each the Z-axis flexible structure set connects to a Z-axis suspension set. In the first embodiment of the present invention, each the Z-axis flexible structure set includes a straight first elastic beam 33 and a straight second elastic beam 35. Also, the first elastic beam 33 has one terminal connected to the Z-axis pivot structure 31 and has another terminal connected to a middle section of the second elastic beam 35. Each the Z-axis suspension set includes two first suspension side beams 52 and a second suspension middle beam 54 that is connected between the two first suspension side beams 52. Moreover, each of the two terminals of the second elastic beam 35 is respectively connected with the two suspension side beams 52, and the hollow area 21 is reserved between the second elastic beam 35 and the second suspension middle beam 54.

Please refer to FIG. 1, FIG. 2, FIG. 3, and FIG. 4. The Z-axis flexible structure set and the Z-axis suspension sets may vary in configuration in different embodiments of the present invention. For example, in FIG. 3, the second elastic beam 35 of the Z-axis flexible structure set includes a multiple-bent (spring-shaped) arm, which may indicate a serpentine beam, and the hollow area 21 is reserved between the multiple-bent arm and the second suspension structure 54. In FIG. 4, the second suspension structure 54 includes a multiple-curved (spring-shaped) beam (which may indicate a serpentine beam) that connects with the first elastic beam 33 of the Z-axis flexible structure set. And the hollow area 21 is formed between the first elastic beam 33, the second suspension structure 54, and the first suspension structure 52. In addition, independent sensing structures, which include the X-axis sensing structure and the Z-axis sensing structure, share multiple MEMS anchoring structures 72 that are located at four corners stretched by two diagonals of the Z-axis sensing structure. In some examples, there are four MEMS anchoring structures 72 located at the four corners inside the side frame of the MEMS wafer 20. Each the MEMS anchoring structure 72 includes a first electrically connecting spring 66, a proof mass anchor 62, and an electrically connecting anchor 64. Specifically, the dotted frame inside the proof mass anchor 62 indicates joints of the cap wafer, and the two dotted frames inside the electrically connecting anchor 64 indicate joints of the CMOS wafer and the cap wafer. In one first embodiment, a first suspension spring 58 is connected in between the first suspension structure 52 of the Z-axis suspension set and the proof mass anchor 62, where the first suspension spring 58 absorbs stress caused by a bending deformation of the proof mass anchor 62 itself. In aspect of the X-axis sensing structure, the X-axis proof mass connects to the proof mass anchor 62 of the MEMS anchoring structure via a third elastic beam 68. In aspect of the Z-axis sensing structure, the Z-axis proof mass connects the first suspension structure 52, the second suspension structure 54, and the first suspension spring 58 to the anchoring structure via the first elastic beam 33 and the second elastic beam 35. The first electrically connecting spring 66 is connected between the proof mass anchor 62 and the electrically connecting anchor 64. The third elastic beam 68, which is an X-axis sensing spring, is connected in between the proof mass anchor 62 and the first proof mass 22 of the X-axis sensing structure. In other words, the anchoring structure connects with the X-sensing structure via multiple connecting springs, and connects with the Z-sensing structure via the Z-axis suspension set, the Z-axis flexible structure set, and the Z-axis pivot structure 31. Two sides of the Z-axis suspension set are held by the proof mass anchor 62 via the first suspension spring 58. And it explains how the X-axis sensing structure and the Z-axis sensing structure of the present invention share a single MEMS anchor set. In this way, a Z-axis pivot structure 31, multiple Z-axis flexible structure set, multiple Z-axis suspension sets, and multiple MEMS anchor sets form a fixed anchor set together. In top-view of the MEMS wafer (i.e. the X-Y plane of the MEMS wafer), the X-sensing structure is an enclosed space surrounded by a frame, the Z-axis sensing structure is disposed in a center region, and the fixed anchor set extends from the center region to two sides and in turn extends laterally from vertical sides of both the sides to four corners of the enclosed space. Moreover, the X-axis sensing structure, the Z-axis sensing structure, and the fixed anchor set may respectively be symmetric to the X-axis.

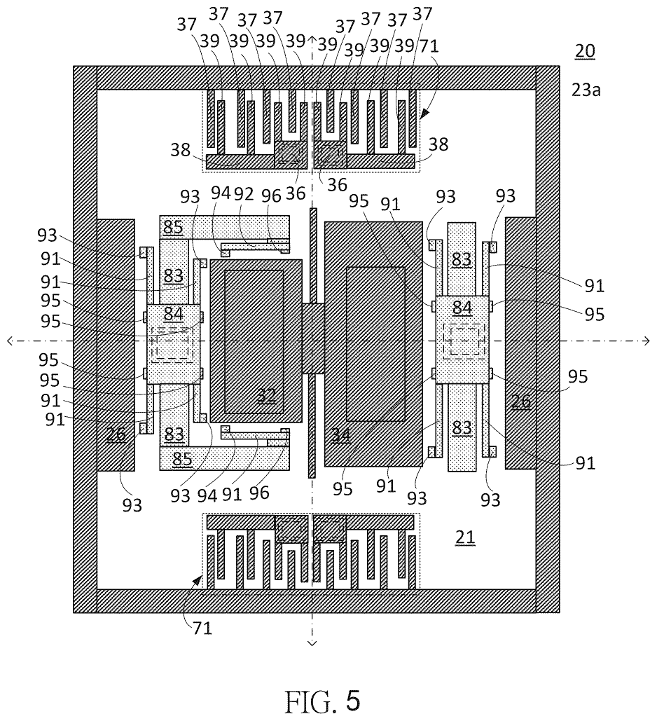

FIG. 5 is a top-view diagram of partial structures of an X-axis sensing structure (in which an X-axis ring-shaped proof mass includes a sensing structure), a Z-axis sensing structure, and a stopper anchor set of the MEMS wafer according to the first embodiment of the present invention. Please refer to FIG. 1, FIG. 2, and FIG. 5. Two stopper anchor sets are respectively disposed inside the hollow areas 21 of the X-axis sensing structure and the Z-axis sensing structure respectively, where the two stopper anchor sets, which include a first anchor stopper set 74 and a second anchor stopper set 76, may be the same or different. One stopper anchor set includes a stopper anchor, multiple connecting arms, multiple stopper springs, multiple spring stopper bumps (i.e., first stopper bumps), and multiple hard stopper bumps (i.e., second stopper bumps). In the first embodiment, a first stopper anchor set 74 is disposed between the third proof mass 26 of the X-axis sensing structure and the first Z-axis proof mass 34 of the Z-axis sensing structure. The first stopper anchor set 74 includes a stopper anchor 84, two first connecting arms 83, four first stopper springs 91, four first spring stopper bumps 93, and four hard stopper bumps 95. The stopper anchor 84 is roughly disposed corresponding to middle sections of the third proof mass 26 and the first Z-axis proof mass 34, and the stopper anchor 84 has a rectangular shape. The two dotted frames inside the stopper anchors 84 shown in FIG. 5 respectively indicate joints of an under CMOS wafer and a top cap wafer. The two straight first connecting arms 83 respectively extend from two comparatively-short sides of the stopper anchor 84, where one side of the first connecting arm 83 is fixed on the stopper anchor 84 and is roughly in parallel with the third proof mass 26 and the first Z-axis proof mass 34. The four straight first stopper springs 91 are respectively disposed near two sides of the two first connecting arms 83 with a distance, where one terminal of each the first stopper spring 91 is fixed on the stopper anchor 84 and is roughly in parallel with the third proof mass 26 and the first Z-axis proof mass 34, and the other terminal of each the first stopper spring 91 is a free end. The four first spring stopper bumps 93 are respectively disposed at the free ends of the four first stopper springs 91, where two first spring stopper bumps 93 protrude towards the first Z-axis proof mass 34 and corresponding to the first Z-axis proof mass 34's coverage, and the other two first spring stopper bumps 93 protrude towards the third proof mass 26 and corresponding to the third proof mass 26's coverage. The four first hard stopper bumps 95 are respectively disposed on two comparatively-long sides of the stopper anchor 84, where two of the first hard stopper bumps 95 protrude towards the first Z-axis proof mass 34 and corresponding to the first Z-axis proof mass 34's coverage, and the other two of the first hard stopper bumps 95 protrude towards the third proof mass 26 and corresponding to the first Z-axis proof mass 34's coverage.

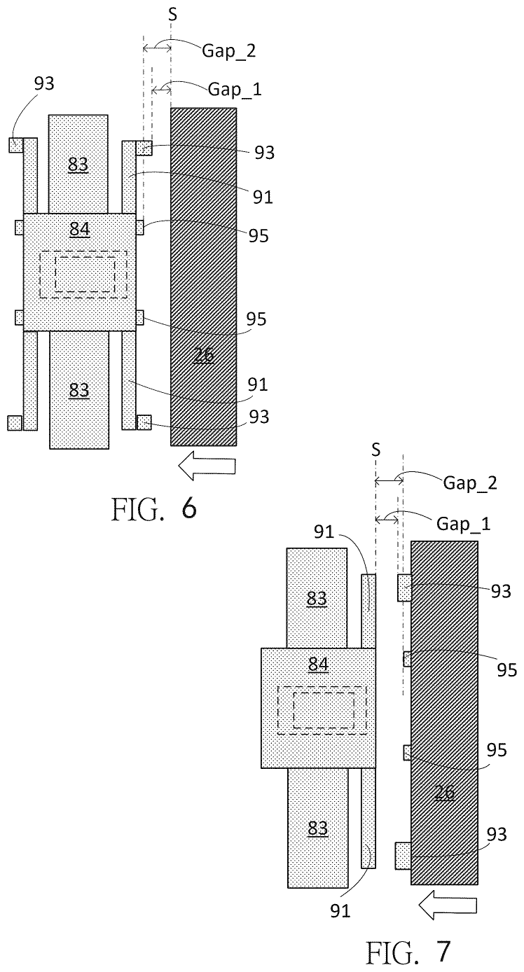

FIG. 6 is a partial zoom-in diagram of FIG. 5. Please refer to FIG. 5 and FIG. 6. A first gap Gap_1 (inside the hollow area 21) is located between the first spring stopper bump 93 and the third proof mass 26, which provides a first stopper surface S. A second gap Gap_2 is located between the first hard stopper bump 95 and the third proof mass 26, which provides a first stopper surface S. In some examples, the first gap Gap_1 is smaller than the second gap Gap_2 for easier contact with the third proof mass 26 and for absorbing a contact force by bending the first stopper spring 91. When the third proof mass 26 is moved leftward (with FIG. 6 illustrating the X-Y plane and the movement follows the arrow sign below the third proof mass 26), the third proof mass 26 is getting closer to a neighboring stopper anchor set, such that both the first gap Gap_1 and the second gap Gap_2 become synchronously smaller. Because the first gap Gap_1 is smaller than the second gap Gap_2, the third proof mass 26 in its leftward movement will firstly contact with the first spring stopper bump 93 to bend the first stopper spring 91. When the third proof mass 26 is moved leftward until the second gap Gap_2 is closed, since the first hard stopper bump 95 is mounted on the stopper anchor 84, the moving third proof mass 26 will be stopped by the first hard stopper bump 95.

FIG. 7 is a top-view diagram of partial structures of an X-axis sensing structure and a stopper anchor of the MEMS according to a second embodiment of the present invention. In comparison to the embodiment shown in FIG. 5, the two first spring stopper bumps 93 and the two first hard stopper bumps 95 shown in FIG. 7 are disposed on one side of the third proof mass 26 of the X-axis sensing structure that faces towards the hollow area, where two first spring stopper bumps 93 are disposed corresponding to the two first stopper springs 91, and two first hard stopper bumps 95 are disposed corresponding to the stopper anchors 84. In this embodiment, there is a first gap Gap_1 between the first spring stopper bump 93 and the first stopper spring 91 that provides a first stopper surface S, there is a second gap Gap_2 between the first hard stopper bump 95 and the stopper anchor 84 that provides a first stopper surface S, and the first gap Gap_1 is shorter than the second gap Gap_2. Please refer to FIG. 1, FIG. 6, and FIG. 7. When the third proof mass 26 is moved leftward (with FIG. 6 illustrating the X-Y plane and the movement follows the same arrow signs as FIG. 6), the stopper anchor set adjacent to the third proof mass 26 remains capable of contacting the moving proof mass and absorbing the contact force by bending the first stopper spring 91. As such, the stopper anchor set includes an elastic stopper structure. There are two types of gaps of different sizes between the moving proof mass and the spring stopper set: a first gap is located between the stopper spring and the proof mass, defined as the distance from the spring stopper bump to the proof mass; and a second gap is located between a fixed structure and the proof mass, defined as the distance from the hard stopper bump to the proof mass. The spring stopper set includes a stopper, a stopper spring, a spring stopper bump, and a hard stopper bump. The first stopper surface S is originated from the X-axis structure, the Z-axis structure, a first connecting arm or a stopper anchor. Therefore, the X-axis sensing structure and the Z-axis sensing structure share a first stopper anchor set 74. Please refer to FIG. 1, FIG. 5, FIG. 6, and FIG. 7. Understandably, operations and element configuration of the first stopper anchor set and the first Z-axis proof mass 34 of the Z-axis sensing structure are described as above, and when the first Z-axis proof mass 34 of the Z-axis sensing structure rotates with respect to the Z-axis on the X-Y plane, the corresponding contact way and functions of the first Z-axis proof mass 34 with the first stopper anchor set 74 are similar and will not be described repeatedly.

Please refer to FIG. 1, FIG. 2, and FIG. 5. In the first embodiment, a second stopper anchor set 76 is disposed between the third proof mass 26 of the X-sensing structure and the second Z-axis proof mass 32 of the Z-axis sensing structure. The second stopper anchor set 76 includes a L-shaped elastic stopper structure that includes all structures of the first stopper anchor set 74 in addition to two second connecting arms 84, two second stopper springs 92, two second spring stopper bumps 94, and two second hard stopper bumps 96. The stopper anchor 84 of the second stopper anchor set 76 is roughly set in the middle section of the third proof mass 26 and the second Z-axis proof mass 32 and is rectangular-shaped. Two dotted frames in FIG. 5 indicate joints of the under CMOS wafer and the top cap wafer respectively. Two straight connecting arms 83 extend from the opposite short sides of the stopper anchor 84. One end of each connecting arm 83 is fixed to the stopper anchor 84, and is generally parallel to the third proof mass 26 and the second Z-axis proof mass 32. Four first straight stopper springs 91 are disposed on either side of the two first connecting arms 83, spaced apart from the connecting arms 83. One end of each the first straight stopper spring 91 is fixed to the stopper anchor 84, and is generally parallel to the third proof mass 26 and the second Z-axis proof mass 32, whereas the other end of each the first straight stopper spring 91 is a free end. Four spring stopper bumps 93 are respectively disposed at the free ends of the four first stopper springs 91. Two of these first spring stopper bumps 93 protrude towards the second Z-axis proof mass 32 and are within its range, while the other two first spring stopper bumps 93 protrude towards the third proof mass 26 and are within the range of the first Z-axis proof mass 34. Four first hard stopper bumps 95 are respectively disposed on the opposite long sides of the stopper anchor 84. Two of these first hard stopper bumps 95 protrude towards the first Z-axis proof mass 34 and are within its range, while the other two first hard stopper bumps 95 protrude towards the third proof mass 26 and are within the range of the second Z-axis proof mass 32.

Please refer to FIG. 1, FIG. 2, and FIG. 5. The second stopper anchor set 76 includes two straight connecting arms 85, each connected to one end of a first connecting arm 83 and perpendicular to said first connecting arm 83. The second connecting arms 85 are generally parallel to the X-axis, and their the other ends are connected to one end of a second stopper spring 92, leaving a hollow space between the second connecting arm 85 and the second stopper spring 92. The second stopper spring 92, which is connected to the second connecting arm 85, is generally parallel to the second connecting arm 85. A second spring stopper bump 94 is disposed at the free end of the second stopper spring 92, and a second hard stopper bump 96 is disposed at a connecting end of the second stopper spring 92 (where the second stopper spring 92 connects to the second connecting arm 85). Both the second spring stopper bump 94 and the second hard stopper bump 96 face towards the second Z-axis proof mass 32 of the Z-axis sensing structure. Similar to the first stopper anchor set 74, the first connecting arms 83 on the second stopper anchor set 76 also provide contact and shock absorption for the X-sensing structure's movement in the X-direction. Such that this repeated mechanism is identical to that described previously for the first stopper anchor set 74 and will not be reiterated here. The second connecting arms 85 on the second stopper anchor set 76 absorb and buffer the impact from the rotational movement of the second Z-axis proof mass 32 of the Z-axis sensing structure on the X-Y plane. Similarly and understandably, as illustrated in FIG. 6 and FIG. 7, each second spring stopper bump 94 is taller than each second hard stopper bump 96, creating the first gap Gap_1 and the second gap Gap_2 shown in FIG. 6 and FIG. 7. Therefore, the first connecting arm 83 and the second connecting arm 85 of the second stopper anchor set 76 form an L-shaped arm. The respective parallel spring stopper structures (e.g. the stopper spring, the spring stopper bump, or the hard stopper bump) restrict displacements in the X-axis direction and the rotational direction, respectively, where these spring stopper structures are orthogonal to each other. In other words, the X-axis sensing structure and the Z-axis sensing structure share the second stopper anchor set 76.

Please refer to FIG. 1 and FIG. 5. Two X-axis sensing comb structures 71 are disposed between the Z-axis suspension set and the second proof mass 24 of the X-axis sensing structure, and between the two MEMS fixing anchor sets 72. Each X-axis sensing comb pair structure 71 includes multiple movable electrode plates 37 and corresponding fixed electrode plates 39 arranged in a comb-shaped structure and spaced apart from each other. The movable electrode plates 37 are connected to the second proof mass 24 of the X-axis sensing structure, while the fixed electrode plates 39 are connected to the connecting comb arms 38 and the connecting comb anchors 36. One end of each connecting comb arm 38 is fixed to one side of a connecting comb anchor 36. The two dotted frames of the connecting comb anchors 36 in FIG. 5 respectively represent the joints between the CMOS wafer and the cap wafer. The X-axis sensing comb pair structure 71 is electrically connected to the CMOS wafer through the connecting comb anchor 36. The operations of the X-axis sensing comb pair structure 71 is conventional and will not be detailed here.

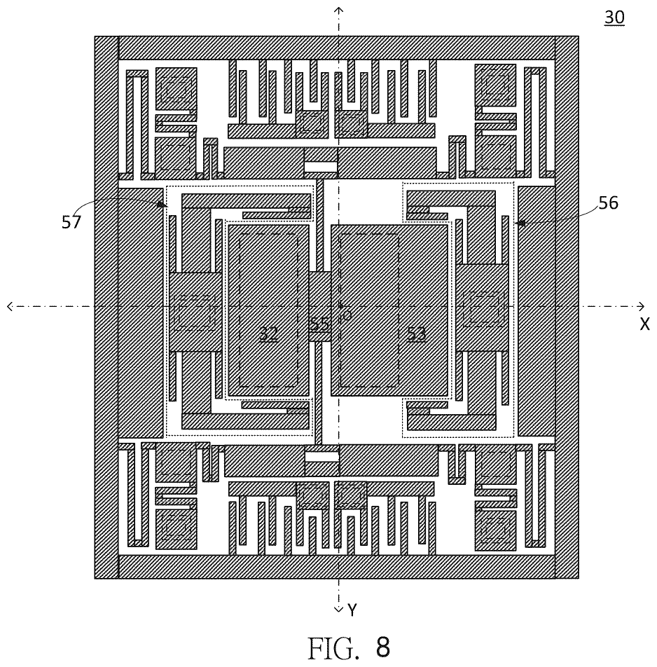

FIG. 8 is a top-view diagram illustrating a structural configuration of the MEMS wafer, which includes the X-axis sensing structure and the Z-axis sensing structure, according to a second embodiment of the present invention. Please refer to FIG. 1 and FIG. 8, in aspect of the X-Y plane, the Z-axis pivot structure 31 of FIG. 1 is located at the center O (the intersection of the X and Y axes) of the MEMS wafer 20, or in other words, the Z-axis pivot structure 31 is disposed on the central Y-axis. In contrast, the Z-axis pivot structure 55 of the fixed anchor set in FIG. 8 is disposed near the center O of the MEMS wafer 30, meaning the Z-axis pivot structure 55 is not positioned on the central Y-axis. Furthermore, the length of the first proof mass 53 of the Z-axis sensing structure of the MEMS wafer 30 along the Y-axis is close to that of the second Z-axis proof mass 32. However, the length of the first proof mass 53 along the X-axis is greater than that of the second Z-axis proof mass 32. Therefore, the Z-axis sensing structure of the MEMS wafer 30 remains a Z-axis seesaw movable structure, where the first proof mass 53 of the seesaw movable structure is larger or heavier than the second Z-axis proof mass 32. Additionally, for the Z-axis sensing structure of the MEMS wafer 30, the sensing electrode plates on the CMOS wafer below the MEMS wafer 30 (represented by the dotted frames at the second Z-axis proof mass 32 and the first proof mass 53 in FIG. 8) are not symmetrical with respect to the central Y-axis of the MEMS wafer 30. Moreover, the shapes and components of the first stopper anchor set 74 and the second stopper anchor set 76 in the first embodiment are different. In contrast, the shapes and components of the first stopper anchor set 56 and the second stopper anchor set 57 in the second embodiment are similar to those of the second stopper anchor set 76 in the first embodiment. Therefore, the first stopper anchor set 56 includes a stopper anchor, two first connecting arms, two second connecting arms, six first stopper springs, six first spring stopper bumps, and six first hard stopper bumps, where connections between these components are the same as those in the second stopper anchor set 76, meaning the first stopper anchor set 56 also includes an L-shaped elastic stopper structure. Furthermore, the positional relationships and operations of the first stopper anchor set 56 and the first proof mass 53 are similar to those of the second stopper anchor set 76 and the second Z-axis proof mass 32 in the first embodiment and will not be reiterated here.

Please refer to FIG. 1 and FIG. 8. Although the above description explains the X/Z dual-axis accelerometer of the present invention with respect to the X and Y axes, it should be understood that the overall structures of both the first and second embodiments can also be rotated 90 degrees to function as a Y/Z dual-axis accelerometer. The sensing axis can also be defined by the packaging orientation in subsequent manufacturing processes. The above description is not intended to limit various applications of the present invention.

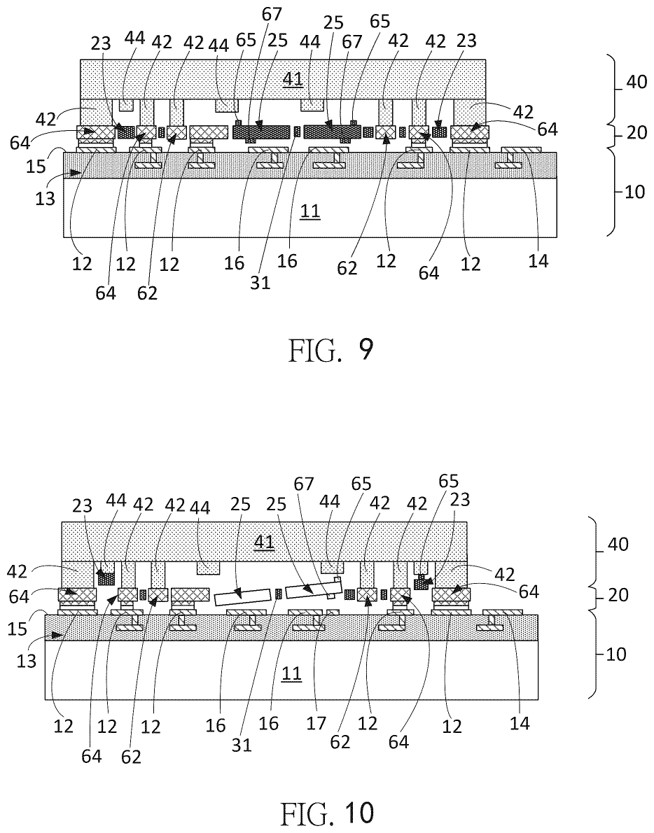

FIG. 9 is a lateral-view schematic diagram of the X/Z-axis accelerometer structure of the present invention. For clarity in illustrating the positional relationships of the partial structures of the three wafers in the X-axis and Z-axis directions, FIG. 9 does not correspond to any specific cross-section of the MEMS wafer in FIG. 1 or FIG. 8. Please refer to FIG. 9. The X/Z-axis accelerometer includes a complementary metal-oxide-semiconductor (CMOS) wafer 10, a MEMS wafer 20, and a cap wafer 40, which are arranged parallel to each other and bonded together, with the MEMS wafer 20 positioned between the CMOS wafer 10 and the cap wafer 40. The CMOS wafer 10 includes a CMOS base layer 11 and a CMOS circuit layer 13 on the surface of the CMOS base layer 11. The CMOS circuit layer 13 includes several conductive structures, such as conductive pads and vias, for electrical connection, conduction, or physical connection. In one embodiment, a first surface 15 of the CMOS circuit layer 13 includes one or more first conductive pads 12 in physical contact with the fusion-bonded MEMS wafer 20 and the cap wafer 40. Solder pads 14 are exposed on the first surface 15 for connection to other structures. One or more sensing electrode plates 16 correspond to the Z-axis sensing structure (seesaw proof mass) of the MEMS wafer 20.

Please refer to FIG. 9 again. The cap wafer 40 includes a cap body 41, several cap pillars 42, and cap stoppers 44 protruding from the cap body 41 towards the MEMS wafer 20. In one embodiment, one or more cap pillars 42 correspond to the first conductive pads 12 of the CMOS wafer 10, and are fixed to the CMOS wafer 10 through the MEMS wafer 20. And one or more cap stoppers 44 are only fixed to the MEMS wafer 20. Furthermore, one or more cap stoppers 44 correspond to the X-axis sensing structure 23 and/or the Z-axis sensing structure 25 of the MEMS wafer 20. The length of the cap stoppers 44 (i.e., the height from the cap wafer 40 towards the MEMS wafer 20) is less than that of the cap pillars 42. In other words, the cap wafer 40 includes two columnar structures of different lengths: the cap pillars 42 for structural connection and the cap stoppers 44 for limiting the stroke of the movable proof mass, forming a cap cavity between the cap wafer 40 and the MEMS wafer 20 with at least two different heights. When the cap pillars 42 are bonded and fixed to the MEMS wafer 20, a gap remains between the cap stoppers 44 and the structures of the MEMS wafer 20.

Please refer to FIG. 1, FIG. 2, and FIG. 9 again. The MEMS wafer 20 has two types of fixed anchor structures. Multiple proof mass anchors 62 serve as the cap fixing anchor structures and are connected to the entire movable sensing structure of the MEMS wafer 20 via elastic structures (e.g., via the first suspension springs 58 and the third elastic beams 68). Multiple electrical connection anchors 64 are electrically connected to the underlying CMOS circuit layer 13 to form an electrical connection anchor structure and are electrically connected to the cap fixing anchor structure, e.g., the proof mass anchors 62, via electrical connection springs, e.g., the first electrical connection springs 66. Thus, the fixed anchor structure of the MEMS sensing structure utilizes two types of anchor structures, serving as the fixing structure and the electrical conduction structure, respectively. Therefore, during the bonding process, because the cap fixing anchor structure (e.g., the proof mass anchors 62) is suspended within the cap cavity, the cracking risk caused by a bonding pressure on the cap fixing anchor structure can be reduced. Furthermore, even if the electrical connection anchor structure (e.g., the electrical connection anchors 64) is cracked because of the bonding, its electrical connection can be maintained without affecting the stability of the sensing structure, thereby improving the manufacturing yield and stability of the product.

Please refer to FIG. 1, FIG. 2, and FIG. 9. One or more cap-direction stoppers 65 and wafer stoppers 67 can be disposed on the upper and lower surfaces, respectively, of the X-axis sensing structure 23 and/or the Z-axis sensing structure 25. That is, the cap-direction stoppers 65 and the wafer stoppers 67 can face towards the CMOS wafer 10 or the cap wafer 40 (i.e., along the Z-axis direction), respectively. In the embodiment of FIG. 9, the cap-direction stoppers 65 and the wafer stoppers 67 are disposed on the upper and lower surfaces, respectively, of the seesaw proof mass of the Z-axis sensing structure 25. The cap-direction stoppers 65 correspond to part or all of the cap stoppers 44, while the wafer stoppers 67 can correspond to the sensing electrode plates 16.

FIG. 10 is another lateral-view schematic diagram of the X/Z-axis accelerometer structure of the present invention. Similar to FIG. 9, FIG. 10 illustrates the positional relationships of partial structures of the three wafers in the X-axis and Z-axis directions, and thus does not correspond to any specific cross-section of the MEMS wafer in FIG. 1 or FIG. 8. Please refer to FIG. 1, FIG. 9, and FIG. 10. The first surface 15 of the CMOS wafer 10 in FIG. 10 further includes a landing pad 17 positioned corresponding to the wafer stopper 67 on the Z-axis sensing structure 25. The X-axis sensing structure 23 (which may be the first, second, or third proof mass) has a cap-direction stopper 65 corresponding to the cap stopper 44 on the cap wafer 40. FIG. 10 shows that acceleration in the Z-axis direction causes a seesaw motion of the Z-axis sensing structure 25. The cap stopper 44, typically around 2-5 μm, may limit the upward movement of the movable MEMS structure towards the cap wafer 40. As shown on the left side of FIG. 10, if the X-axis sensing structure 23 does not have a cap-direction stopper 65, when the X-axis sensing structure 23 moves upwards and contacts the cap stopper 44, a large-area contact may occur, potentially leading to irreversible sticking. In contrast, the right side of FIG. 10 shows the X-axis sensing structure 23 with a cap-direction stopper 65 that contacts with the cap stopper 44 with a smaller area of the cap-direction stopper 65, thus preventing sticking. The cap-direction stopper 65 on the Z-axis sensing structure 25 functions similarly to the cap-direction stopper 65 on the X-axis sensing structure and will not be further elaborated upon here.

Please refer to FIG. 1, FIG. 9, and FIG. 10. When a downward seesaw motion of the Z-axis sensing structure 25 occurs due to acceleration in the Z-axis direction, the wafer stopper 67 on the Z-axis sensing structure 25 limits the movement of the movable MEMS structure towards the CMOS wafer 10. When the movable MEMS structure contacts the landing pad 17, the contact area between them is further reduced, preventing sticking. Preferably, the landing pad 17 should be electrically connected to the movable MEMS structure.

According to the above description, the overall structure of the X/Z-axis accelerometer of the present invention is symmetrical with respect to the X-axis. A stopper anchor structure is located in the hollow area between the X-axis sensing structure and the Z-axis sensing structure. The function of the stopper anchor structure is to absorb impact force and limit the maximum stroke of the proof mass during displacement.

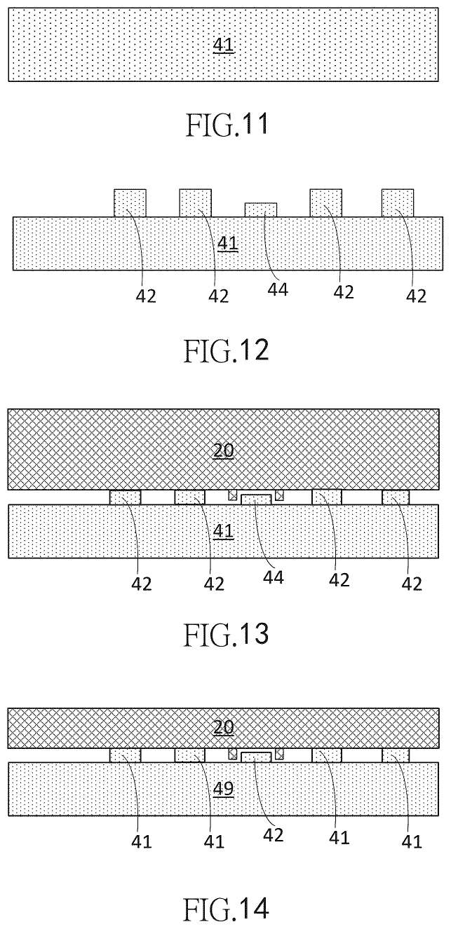

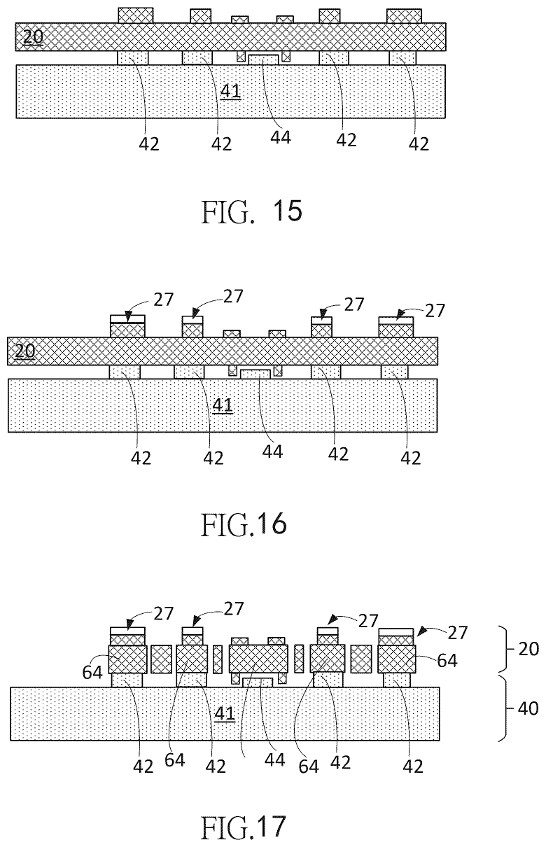

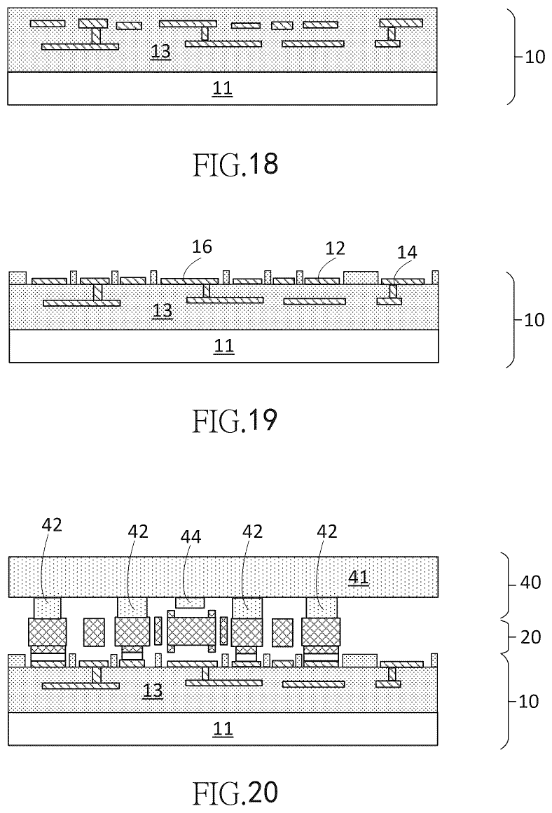

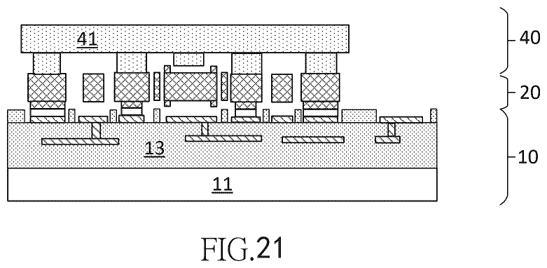

FIG. 11 through FIG. 21 are cross-sectional schematic diagrams illustrating the fabrication process of the X/Z-axis accelerometer according to several embodiments of the present invention. Note that FIG. 11 through FIG. 21 illustrate the steps of the fabrication process and do not focus on the relations between structures. Therefore, individual structures of the wafers shown in FIG. 1 through FIG. 10 may not be shown on the partial structures in the same process step. However, this does not mean that the individual structures are not formed in the same step. Please refer to FIG. 9, FIG. 10, FIG. 11, and FIG. 12. A cap body 41 is provided, and cap pillars 42 and cap stoppers 44 of different heights are fabricated on the surface of the cap body 41 through standard patterning steps such as lithography, exposure, development, and etching. The height of the cap pillars 42 is greater than that of the cap stoppers 44. Please refer to FIG. 9, FIG. 10, FIG. 13, and FIG. 14. The original MEMS wafer 20 (the original wafer) is bonded to the patterned cap body 49 using a suitable method such as fusion bonding, and the original MEMS wafer 20 is thinned. Please refer to FIG. 9, FIG. 10, FIG. 15, FIG. 16, and FIG. 17. Layers are deposited and patterned on the thinned MEMS wafer 20 using a suitable method to form bonding structures 27, and then MEMS sensing structures are formed, including the X-axis sensing structure, the Z-axis sensing structure, the MEMS fixed anchor sets, the stopper anchor sets, and the sensing comb pair structures. Please refer to FIG. 9, FIG. 10, FIG. 18, and FIG. 19. A CMOS circuit layer 13 is formed on top of the CMOS base layer 11 of the CMOS wafer using conventional methods, and several conductive pads 12, solder pads 14, electrode plates 16, etc., are exposed on the surface through suitable etching. Please refer to FIG. 9, FIG. 10, FIG. 20, and FIG. 21. The combined MEMS wafer 20 and the cap wafer 40 are flipped and bonded to the CMOS wafer 10 using a suitable method such as eutectic bonding. If necessary, the cap wafer 40 is further thinned and sawed, along with the MEMS wafer 20, to obtain the X/Z-axis accelerometer of the present invention.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

While the above description describes certain examples of the invention, and describes the best mode contemplated, no matter how detailed the above appears in text, the present technology can be practiced in many ways. Details of the system may vary considerably in its specific implementation, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific examples disclosed in the specification, unless the above Detailed Description section explicitly defines such terms. Accordingly, the actual scope of the present technology encompasses not only the disclosed examples, but also all equivalent ways of practicing or implementing the invention under the claims.

It can be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A capacitive dual-axis accelerometer having a Z-axis, the accelerometer comprises a complementary metal-oxide-semiconductor (CMOS) wafer, a micro-electro-mechanical system (MEMS) wafer, and a cap wafer, wherein the CMOS wafer, the MEMS wafer, and the cap wafer are disposed parallel to each other and bonded together, and wherein the MEMS wafer comprises:
an X-axis sensing structure forming a frame that defines a hollow area;
a Z-axis sensing structure, disposed within the hollow area and located at a central location within the defined frame of the X-axis sensing structure, wherein the Z-axis sensing structure comprises a first Z-axis proof mass and a second Z-axis proof mass, and wherein the first Z-axis proof mass and second Z-axis proof mass form a seesaw proof mass;
four MEMS fixed anchor sets, respectively disposed within the hollow area at four corners of the defined frame of the X-axis sensing structure, wherein each the MEMS fixed anchor set comprises a connecting anchor which each the MEMS fixed anchor set uses to fix to the CMOS wafer and the cap wafer;
a Z-axis pivot structure, connected to the MEMS fixed anchor sets and disposed between and connected to the first Z-axis proof mass and the second Z-axis proof mass of the Z-axis sensing structure; and
two stopper anchor sets, disposed within the hollow area and located between the X-axis sensing structure and the Z-axis sensing structure, respectively, wherein each the stopper anchor set comprises:
a stopper anchor respectively fixed to the CMOS wafer and the cap wafer;
a plurality of first connecting arms and a plurality of first stopper springs coupled to the stopper anchor, which is disposed between the plurality of first connecting arms and the plurality of first stopper springs;
a plurality of first spring stopper bumps, located between the X-axis sensing structure or the Z-axis sensing structure and any one of the first connecting arms, wherein a first gap is defined between each the first spring stopper bump and a first stop surface; and
a plurality of hard stopper bumps, located between the X-axis sensing structure or the Z-axis sensing structure and the stopper anchor, wherein a second gap is defined between each the hard stopper bump and the first stop surface, and wherein the first gap is shorter than the second gap, and the first stop surface is from the group consisting of the X-axis sensing structure, the Z-axis sensing structure, the plurality of first connecting arms, and the stopper anchor.

2. The capacitive dual-axis accelerometer of claim 1, wherein each of the stopper anchor sets further comprises:
a plurality of second connecting arms;
a plurality of second stopper springs;
a plurality of second spring stopper bumps; and
a plurality of second hard stopper bumps;
wherein each the second connecting arm is orthogonally connected to each the first connecting arm, each the second stopper spring is coupled to one of the second connecting arms and is located between the coupled second connecting arm and the Z-axis sensing structure,
the plurality of second spring stopper bumps and the plurality of second hard stopper bumps are respectively disposed on the second stopper springs and are located between the plurality of second stopper springs and the Z-axis sensing structure, and the height of each the second spring stopper bump is greater than the height of each the second hard stopper bump.

2. The capacitive dual-axis accelerometer of claim 1, further comprising:
a plurality of Z-axis elastic structure set; and
a plurality of Z-axis suspension sets;
wherein the plurality of Z-axis elastic structure sets are respectively connected to the Z-axis pivot structure and are located between the first Z-axis proof mass and the second Z-axis proof mass of the Z-axis sensing structure, and the plurality of Z-axis suspension sets connect the Z-axis elastic structure sets and the four MEMS fixed anchor sets.

3. The capacitive dual-axis accelerometer of claim 3, wherein each the MEMS fixed anchor set further comprises:
an electrical connection anchor;
a first electrical connection spring; and
a proof mass anchor;
wherein a first suspension spring connects the Z-axis suspension set and the proof mass anchor, and the first electrical connection spring connects the proof mass anchor and the electrical connection anchor.

4. The capacitive dual-axis accelerometer of claim 3, further comprising:
a plurality of X-axis sensing comb pair structures, disposed within the hollow area and respectively located between the X-axis sensing structure and each the Z-axis suspension set;
wherein each the X-axis sensing comb pair structure comprises a plurality of movable electrode plates connected to the X-axis sensing structure.

5. The capacitive dual-axis accelerometer of claim 1, wherein the cap wafer comprises:
a plurality of cap pillars facing the MEMS wafer; and
a plurality of cap stoppers;
wherein the cap wafer and the MEMS wafer are connected via the plurality of cap pillars, the plurality of cap stoppers are positioned corresponding to the X-axis sensing structure or the Z-axis sensing structure, and a height of the plurality of cap stoppers is less than a height of the plurality of cap pillars.

6. The capacitive dual-axis accelerometer of claim 6, further comprising a plurality of cap stoppers disposed on the X-axis sensing structure and/or the Z-axis sensing structure, wherein the plurality of cap stoppers face the cap wafer and correspond to the plurality of cap pillars.

7. The capacitive dual-axis accelerometer of claim 1, further comprising a plurality of wafer stoppers disposed on the first Z-axis proof mass and/or the second Z-axis proof mass of the Z-axis sensing structure, wherein the plurality of wafer stoppers face towards the CMOS wafer.

8. A capacitive dual-axis accelerometer comprising a Z-axis, the accelerometer comprises a complementary metal-oxide-semiconductor (CMOS) wafer, a micro-electro-mechanical system (MEMS) wafer, and a cap wafer, wherein the CMOS wafer, the MEMS wafer, and the cap wafer are disposed parallel to each other and bonded together, and wherein the MEMS wafer comprises:
an X-axis sensing structure forming a frame defining a hollow area;
a Z-axis sensing structure disposed within the hollow area and at a central location within the frame of the X-axis sensing structure, the Z-axis sensing structure comprising a first Z-axis proof mass and a second Z-axis proof mass forming a seesaw proof mass; and
a stopper anchor set disposed within the hollow area and located between the X-axis sensing structure and the Z-axis sensing structure, the stopper anchor set comprising:
a stopper anchor fixed to the CMOS wafer and the cap wafer;
a plurality of first connecting arms and a plurality of first stopper springs coupled to the stopper anchor, wherein the stopper anchor is disposed between the first connecting arms and the first stopper springs;
a plurality of first spring stopper bumps located between the X-axis sensing structure or the Z-axis sensing structure and any one of the first connecting arms, wherein a first gap is defined between each the first spring stopper bump and a first stop surface;
a plurality of hard stopper bumps located between the X-axis sensing structure or the Z-axis sensing structure and the stopper anchor, wherein a second gap is defined between each the hard stopper bump and the first stop surface, the first gap is smaller than the second gap, and the first stop surface is from the group consisting of the X-axis sensing structure, the Z-axis sensing structure, the first connecting arms, and the stopper anchor;
a plurality of second connecting arms, each the second connecting arm is orthogonally connected to each the first connecting arm;
a plurality of second stopper springs, each the second stopper spring coupled to one of the second connecting arms; and
a plurality of second spring stopper bumps and a plurality of second hard stopper bumps located between the plurality of second stopper springs and the Z-axis sensing structure; and
a fixed anchor set disposed within the hollow area, wherein the X-axis sensing structure and the Z-axis sensing structure are respectively fixed to the cap wafer and electrically connected to the CMOS wafer, via the fixed anchor set, the fixed anchor set comprising:
a Z-axis pivot structure located between and connected to the first proof mass and the second proof mass of the Z-axis sensing structure;
a plurality of Z-axis elastic structure sets respectively connected to the Z-axis pivot structure and located between the first proof mass and the second proof mass of the Z-axis sensing structure, wherein each the Z-axis elastic structure set comprises a first elastic beam and a second elastic beam orthogonal to each other, wherein one end of the first elastic beam is connected to the Z-axis pivot structure and the other end of the first elastic beam is connected to the second elastic beam;
a plurality of Z-axis suspension sets connected to the plurality of second elastic beams; and
a plurality of MEMS fixed anchor sets located at four corners of the frame of the X-axis sensing structure and connected to the Z-axis suspension sets, wherein each the MEMS fixed anchor set comprises a proof mass anchor, a first electrical connection spring, and an electrical connection anchor, wherein the electrical connection anchor is fixed to the CMOS wafer and the cap wafer, the first electrical connection spring connects the proof mass anchor and the electrical connection anchor, and each the MEMS fixed anchor set is connected to the cap wafer via the proof mass anchor.

9. A method of fabricating the capacitive dual-axis accelerometer having a Z-axis of claim 1, the method comprising:
providing the cap wafer;
fusion bonding an original wafer to the cap wafer;
patterning the original wafer to form the MEMS wafer;
providing the CMOS wafer; and
eutectically bonding the MEMS wafer and the CMOS wafer.
